(19) United States
(12) Patent Application Publication
(10) Pub. No.: US 2015/0136267 A1
(43) Pub. Date: May 21, 2015

(54) SINGLE STREAM DISCHARGE DRAIN HOSE ASSEMBLY

(71) Applicant: Aqua Sure, Inc., Concord, CA (US)

(72) Inventor: Michael Yu, Concord, CA (US)

(21) Appl. No.: 14/503,652

(22) Filed: Oct. 1, 2014

Related U.S. Application Data
(60) Provisional application No. 61/905,925, filed on Nov. 19, 2013.

(51) Int. Cl. E03C 1/12; F16L 11/18

(52) U.S. Cl. CPC E03C 1/12; F16L 11/18
USPC 138/109

(57) ABSTRACT

A drain hose assembly comprises an articulated extendable flexible hose having a plurality of articulating sections, the flexible hose further includes a first end configured to couple to a sink drain, a U-bend pipe integrally coupled to a second end of the articulated extendable flexible hose configured to couple to a drain pipe, and a first slip nut fastener operable to securely fasten the first end to the sink drain, and a second slip nut fastener operable to securely fasten the second end to the drain pipe.

### RELATED APPLICATION

The present patent application claims the benefit of U.S. Provisional Patent Application No. 61/905,925 filed on Nov. 19, 2013.

### FIELD

The present disclosure relates to the field of plumbing assemblies, and more particularly to a single stream discharge drain hose assembly.

### BACKGROUND

In 1775 Alexander Cummings invented the S-bend trap. In 1880 Thomas Crapper introduced the U-shaped trap. These bends in the drain pipe are used to prevent sewer gases from entering the interior of buildings. Today the bottle trap is still used in Europe and many parts of the world, but the most commonly used trap in houses, is referred to as the P-trap. It is the addition of a 90 degree fitting and the extension on the outlet side of a U-bend that creates a P-like shape.

Generally the conventional drain assembly connects many pieces of tubing or pipe to complete the assembly. The long and short pieces of rigid tubing have tremendous leverage against the very small contact points between the pipe segments. Very small movement of the tubing or pipe could easily cause the pieces to become misaligned and loose at the joints, and cause leakage.

In certain areas of the world, the drain trap is typically haphazardly constructed a prefabricated PVC flexible hose with a tailpiece on both sides. If installed properly it will do the job. The simplicity of the concept by using only one flexible hose for the entire conduit is great.

With some improvements this concept can be lifted to another level. In some installations, the drain is constructed using a segment of flexible hose with a first end attached to a galvanized nipple of the sink drain, and the second end is merely inserted into the drainage pipe on the floor without any coupling. This type of installation is unsightly, unprofessional, and can easily cause flooding in the room due to the flexible hose being inadvertently knocked or pulled out of the drainage pipe. Due to the long length of the flexible hose that is stretched and sagging to the floor due to the weight of the water, the life expectancy of the flexible hose is significantly reduced. Further, such installation is not standardized to control the height of the water column trapped in the hose. The galvanized nipple is also prone to rust and not easily adaptable to accommodate a dishwater's discharge hose.

### BRIEF DESCRIPTION OF THE DRAWINGS

FIG. 1 is a side elevational view of an exemplary embodiment of a single stream discharge drain hose assembly according to the teachings of the present disclosure;

FIG. 2 a side elevational view of another exemplary embodiment of a single stream discharge drain hose and wall mount U trap assembly according to the teachings of the present disclosure;

FIG. 3 is an elevational view of an exemplary embodiment of a single stream discharge drain hose and floor mount U trap assembly according to the teachings of the present disclosure;

FIG. 4 is a side elevational view of yet another exemplary embodiment of a single stream discharge drain hose and drain trap assembly with an angled tailpiece according to the teachings of the present disclosure;

FIGS. 5 and 6 are front and side views of an exemplary embodiment of a single stream discharge drain trap and hose assembly with an up to 90 degree tailpiece according to the teachings of the present disclosure; and

FIG. 7A-7C are detailed views of an exemplary embodiment of a slotted reducing insert adaptor for coupling a slip nut fastener according to the teachings of the present disclosure.

### DETAILED DESCRIPTION

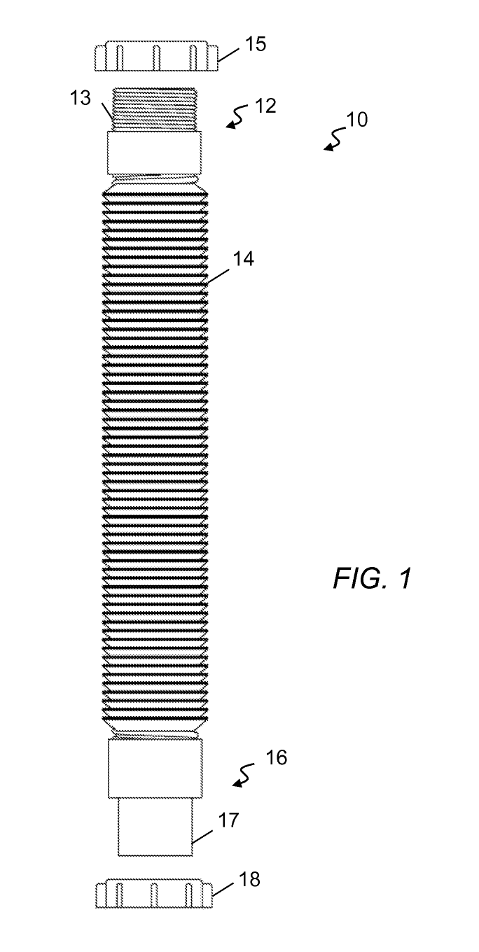

FIG. 1 is a side elevational view of an exemplary embodiment of a single stream discharge drain hose assembly 10 according to the teachings of the present disclosure. A first end 12 of an extendable semi-rigid flexible hose 14 is configured to be secured to a sink drain tailpiece with a slip nut 15 or another form of clamp or fastener. The first end 12 of the extendable articulated flexible hose 14 may incorporates a male pipe thread (MPT) fitting 13 that is configured to be coupled to the drain tailpiece of a sink. A second end 16 of the extendable articulated flexible hose 14 is configured to be coupled to a wall or floor drain with a slip nut 18 or another type of clamp or fastener. The second end 16 may incorporate a tailpiece 17 that is configured to be coupled to the floor or wall drain trap. The extendable articulated flexible hose 14 has a plurality of articulating sections that allow the stretching, manipulation, and positioning of the hose. The extendable articulated flexible hose 14 is an articulated structure that can be stretched, refracted, bent, rotated, and generally positioned and oriented, where the hose stays generally in that positioned and oriented state unless the forces acting on it to change its articulated position.

The basic form of the extendable articulated flexible hose 14 can be constructed with different configurations of sink tailpiece and drain pipe to best suit the needs of various installations and applications. For example, for a wheelchair accessible home, the rigid plumbing under most sinks present a problem for wheelchair-bound homeowners. The single stream discharge drain hose assembly 10 described herein provide a unique, easy to install, and cost-effective way of making space under sinks to accommodate wheelchair users.

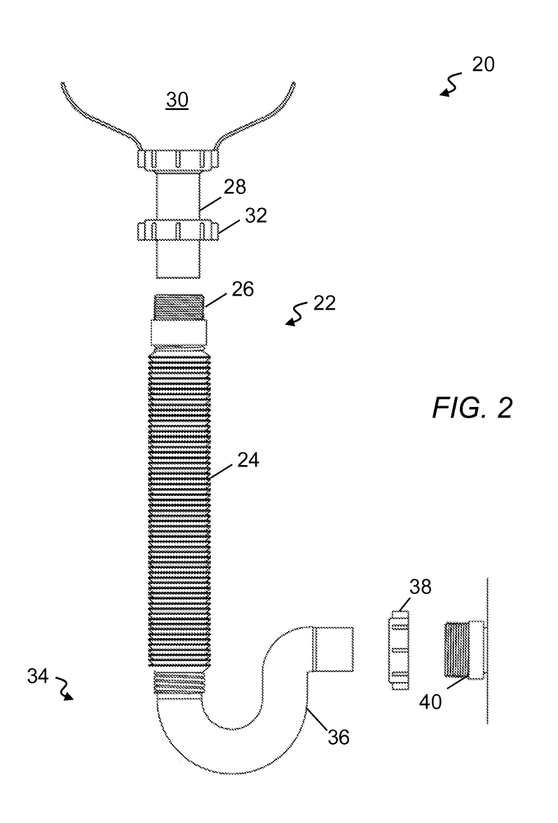

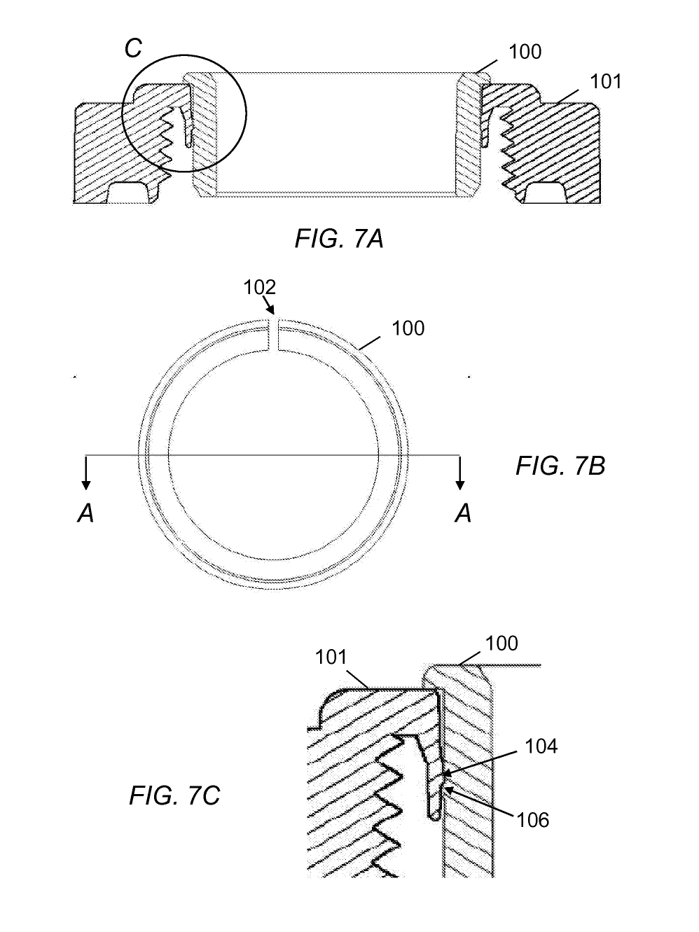

FIG. 2 a side elevational view of another exemplary embodiment of a single stream discharge drain hose assembly 20 according to the teachings of the present disclosure. A first end 22 of the extendable articulated flexible hose 24 incorporates a male pipe thread (MPT) fitting 26 that is configured to be coupled to the drain tailpiece 28 of a sink 30 by a slip nut 32 or another type of fastener. At the second end 34, an integrated U-bend pipe 36 can be connected using a slip nut 38 or another type of fastener to a MPT adapter 40 coupled to a floor drain or a wall-mounted drain. The depth and U-shape of the pipe 36 determine the depth of the water that remains in the pipe. The water depth is approximately 2″ to 4″ which conforms with international plumbing standards. A slotted reducing adaptor insert (described below in conjunction with references to FIGS. 7A-7C) may be used to efficiently reduce the inside diameter of the slip nut 32 (1½″ for kitchen tail pipe) to a smaller size such as 1¼″ for a bathroom sink drain tail pipe.

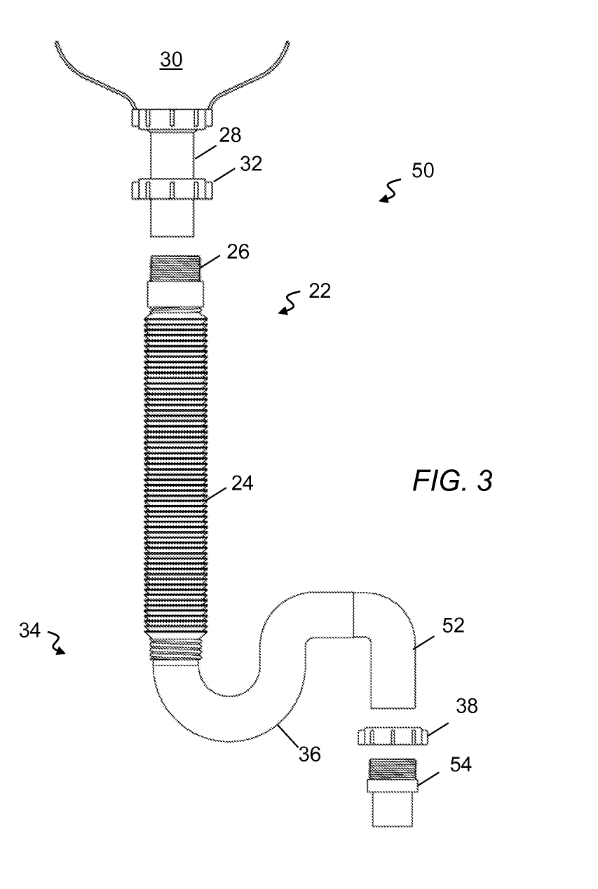

FIG. 3 is an elevational view of another exemplary embodiment of a single stream discharge drain hose assembly according to the teachings of the present disclosure. The embodiment in FIG. 3 is very similar to that shown in FIG. 2. As before, the first end 22 of the extendable articulated flexible hose 24 incorporates a male pipe thread (MPT) fitting 26 that is configured to be coupled to the drain tailpiece 28 of a sink 30 by a slip nut 32 or another type of clamp or fastener. At the second end 34, an integrated U-bend pipe 36 can be connected to another piece of rigid extender pipe 52 that enable a smooth transition to a floor drain. Again, a slip nut 38 or another type of fastener may be used to couple the extender pipe 52 to the MPT adapter 54 coupled to the floor drain.

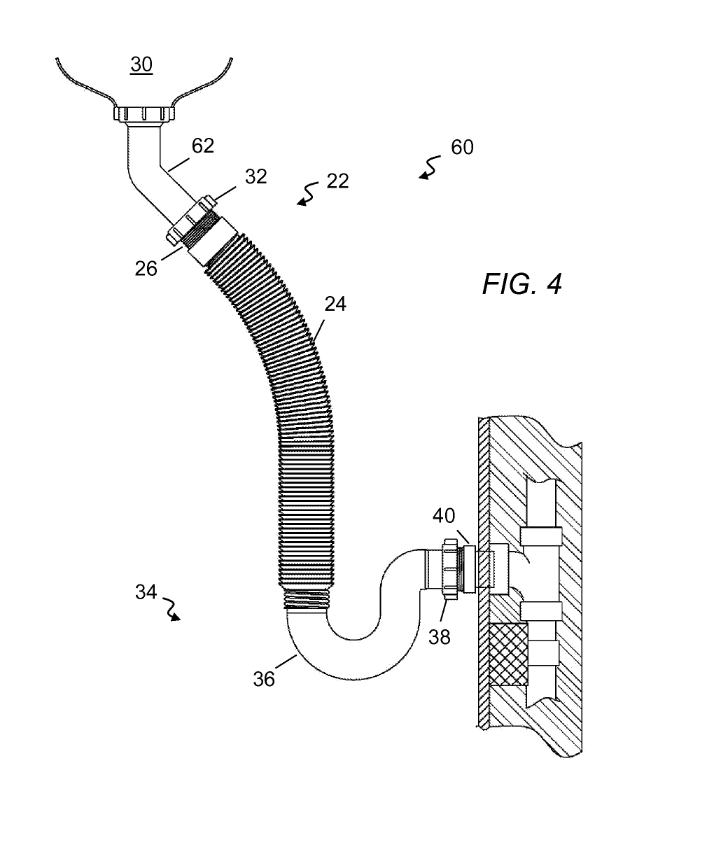

FIG. 4 is a side elevational view of yet another exemplary embodiment of a single stream discharge drain hose assembly 60 with an angled tailpiece 62 according to the teachings of the present disclosure. The tailpiece (or angled tailpiece) for the sink is part of the sink's hardware, it will fit in to the slip nut 32 regardless of whether it is straight or bent. The flange end of the tailpiece 62 is secured to the bottom of the sink by a female pipe thread (FPT) fitting (part of the sink hardware), and a second end of the tailpiece 62 is secured by the slip nut 32 which is part of the hose and drain assembly 60. The angled tailpiece 62 frees up additional space under the sink for storage and wheelchair access. The angled tailpiece 62 may also be used with a straight or U-bent tailpiece connection to the floor drain.

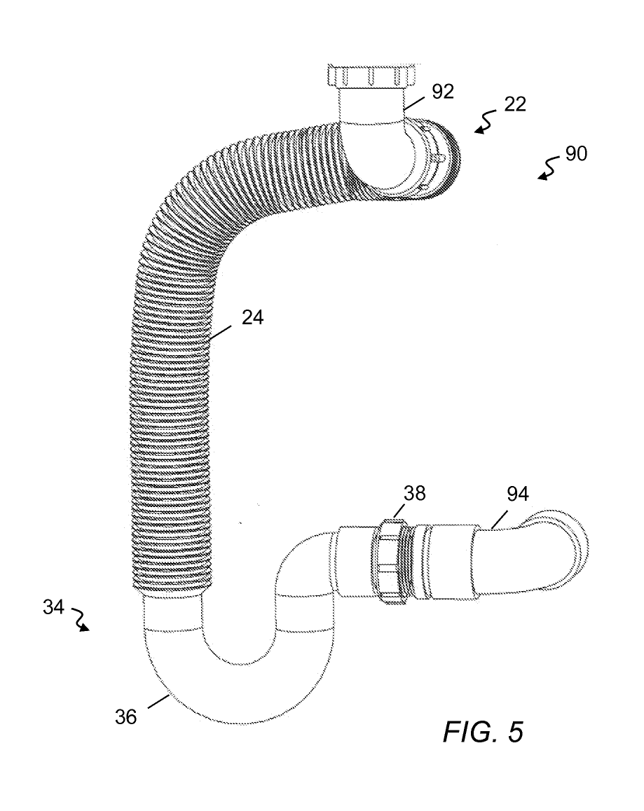

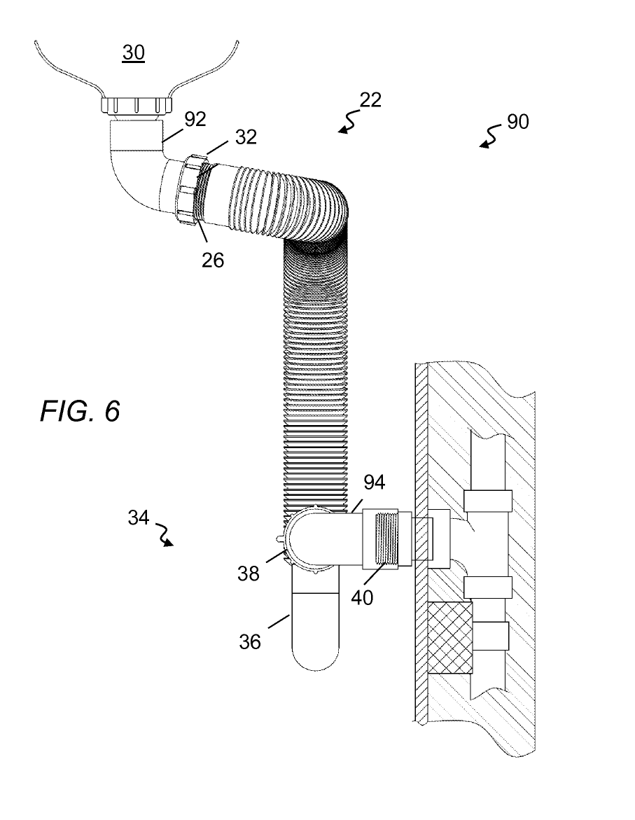

FIGS. 5 and 6 are different side views of yet another exemplary embodiment of a single stream discharge drain hose assembly 90 with an up to 90 degree tailpiece 92 according to the teachings of the present disclosure. A first end 22 of the extendable articulated flexible hose 24 incorporates a male pipe thread (MPT) fitting 26 that is configured to be coupled to a drain tailpiece 92 of a sink 30 with an up to 90 degree bend. A slip nut 32 or another type of fastener may be used to couple the MPT fitting 26 to the tailpiece 92. At the second end 34, an integrated U-bend 36 (or U bend assembly 36) has a tailpiece that is securely connected by the slip nut 38 to the MPT fitting, which is part of the fitting assembly 94 (generally three fittings include a 90 degree elbow is used) that enable a smooth transition to a wall or floor drain. In this embodiment, the 90 degree bend in the tailpiece is preferably oriented toward the back of the sink and the wall. This positions the flexible hose 24 closer toward the wall, where it is out of the way to provide more space under the sink to permit wheelchair access. Further, in non-wheelchair applications, this discharge drain hose assembly configuration provides added valuable storage space under the sink.

Installation is extremely simple and no tools are needed. Because the extendable articulated flexible hose can be manipulated to adjust its length, shape, and angle, the sink drain and the floor/wall drain do not have to be in alignment or be any specified distance apart. The discharge drain hose assembly can be easily manipulated to adapted to many different applications. Because of its single piece construction, the homeowner only has to connect the two ends of the device to the sink drain and floor/wall drain. The slip nut coupling requires no tools for installation. There is no connection between the hose and the U trap that could become loosened and cause leakage. Further, because the rigid portion of the device, the U trap is closer to the floor/wall drain, it is more out of the way to make more room for under-sink storage space. This configuration makes it especially ideal for certain applications, such as in a handicap accessible residence.

The weight of the water discharged from the sink drain is properly supported by the semi-rigid but flexible hose and the rigid U-bend pipe. The integrity of the extendable articulated flexible hose, the U shape of the trap, and thus the height of the water column in the hose is maintained. The installation can be done easily and quickly without the use of any tools, and the result is professional and neat. If the assembly has to be taken apart to recover lost items, it can be easily disassembled without tools.

The materials used to construct the extendable articulated flexible hose, slip nut, and the U-bend pipe may be any sturdy material such as a plastic that may include a synthetic or semi-synthetic organic polymer, including thermoplastic (polyethylene, polypropylene, polystyrene, polyvinyl chloride (PVC), and Ethylene Vinyl Acetate (EVA), thermosetting polymers, or another suitable material. The extendable articulated flexible hose is an articulated structure that can be stretched, retracted, bent, rotated, and generally positioned and oriented by the installer, and will maintain its position and orientation.

FIGS. 7A-7C are views of an exemplary embodiment of a slotted reducing insert adaptor 100 for reducing the diameter of a slip nut 101. The slotted reducing insert adaptor 100 comprises a generally tube with a circular cross-section having a longitudinal slot 102 formed in its circumference. The insert adaptor 100 further comprises an annular rib 104 (see FIG. 7C) operable to engage a corresponding nub 106 on the slip nut 101 (see FIG. 7A). These structures ensures a tight and secure engagement between the slip nut 101 and the slotted reducing insert adaptor 100. The slotted reducing insert adaptor 100 enables a secure coupling between the flexible hose drain assembly with the sink drain tailpiece and/or the floor/wall drain despite some mismatch in their diameters.

In general practice, the kitchen sink has a 1½″ discharge opening and the bathroom sink has a 1¼″ discharge opening. The tailpieces are also coordinated to the same size. Preferably, the discharge drain hose assembly described herein uses standard 1½″ size dimension to coincide with typical household drain pipe adaptor size. Generally the bathroom drain is 1¼″, the 1¼″ sink tailpiece has to be adapted to the 1½″ hose and fittings. The slotted reducing insert adaptor 100 uses a wedge design, which enables a greater and sustainable force from the slip nut 101 to the pipe tailpiece. It is as if a thin wedge is driven into a log making it difficult to pull out or loosen. This same principal makes the slip nut able to hold the pipe tailpiece in place tighter and longer. It is not using the compression principle. It is easier to spring back especially by using nylon material for the slip nut. It therefore has less chance to leak. The slotted reducing insert adaptor 100 can be inserted in to the 1½″ slip nut to reduce it to a 1¼″ slip nut and thus be able to transfer the tightening wedge force through the slotted reducing ring to the 1¼″ tailpiece effectively and directly.

The bathroom tailpiece generally comes with a new faucet which is constructed of metal. It is usually not 100% round, X and Y (diameters in cross measurement) could be off by a ½ mm, and without the slotted reducing insert adaptor it is difficult or impossible to insert the tailpiece into the slip nut if a solid reducing ring is used in order to reduce the 1½″ slip nut to 1¼″ to fit into the bathroom tailpiece. The slotted reducing insert adaptor 100 makes insertion of the tailpiece into the slip nut 101 more easily given the tolerance in plumbing dimensions. Further, the slot of the slotted reducing insert adaptor 100 enables the slip nut 101 to directly transfer its force to clamp around the tailpiece tightly and making the coupling extremely secure.

Although the present description describes a specific preferred embodiment employing slip nut fasteners to secure the flexible hose to the sink drain and the wall/floor drain, other suitable clamps and fasteners may be used.

The features of the present invention which are believed to be novel are set forth below with particularity in the appended claims. However, modifications, variations, and changes to the exemplary embodiments described above will be apparent to those skilled in the art, and the single stream discharge drain hose assembly described herein thus encompass such modifications, variations, and changes and are not limited to the specific embodiments described herein.

What is claimed is:

1. A drain hose assembly comprising:
an articulated extendable flexible hose having a plurality of articulating sections, the flexible hose further includes a first end configured to couple to a sink drain;
a U-bend pipe integrally coupled to a second end of the articulated extendable flexible hose configured to couple to a drain pipe; and
first slip nut fastener operable to securely fasten the first end to the sink drain, and second slip nut fastener operable to securely fasten the second end to the drain pipe.

2. The drain hose assembly of claim 1, further comprising a slotted reducing insert adaptor having a generally tubular shape with a longitudinal slot formed in its circumference, the insert further comprising an annular rib operable to engage a corresponding nub on one of the first and second slip nut fasteners.

3. The drain hose assembly of claim 1, further comprising an angled tailpiece configured for coupling the articulated extendable flexible hose to the sink drain.

4. The drain hose assembly of claim 1, further comprising an up to 90 degree tailpiece configured for coupling the articulated extendable flexible hose to the sink drain.

5. The drain hose assembly of claim 1, further comprising an extender pipe configured to couple the U-bend pipe to a drain pipe.

6. The drain hose assembly of claim 1, wherein the first end of the flexible hose further comprises a male pipe thread.

7. The drain hose assembly of claim 1, wherein the second end of the flexible hose further comprises a tailpiece.

8. A sink-to-drain pipe drain hose assembly, comprising:
a semi-rigid flexible hose having a plurality of articulating sections that may be positioned and oriented to adjust the length, shape, angle, and rotation, the hose further includes a first end configured to couple to a sink drain tailpiece;
a U-bend pipe integrally coupled to the flexible hose and having a second end having a tailpiece configured to couple to a male pipe thread adapter coupled to a drain pipe; and
first slip nut fastener operable to securely fasten the first end to the sink drain tailpiece, and second slip nut fastener operable to securely fasten the U-bend pipe tailpiece to the drain pipe male pipe thread adapter.

9. The drain hose assembly of claim 8, further comprising a slotted reducing insert adaptor having a generally tubular shape with a longitudinal slot formed in its circumference, the insert further comprising an annular rib operable to engage a corresponding nub on one of the first and second slip nut fasteners.

10. The drain hose assembly of claim 8, further comprising an angled tailpiece configured for coupling the articulated extendable flexible hose to the sink drain.

11. The drain hose assembly of claim 8, further comprising an up to 90 degree tailpiece configured for coupling the articulated extendable flexible hose to the sink drain.

12. The drain hose assembly of claim 8, further comprising an extender pipe configured to couple the U-bend pipe to a drain pipe.

13. A drain hose assembly comprising:
a semi-rigid flexible hose having a plurality of extendable sections, the flexible hose further includes a first end configured to couple to a sink drain and a second end configured to couple to one of a wall and floor drain; and
first fastener operable to securely fasten the first end to the sink drain, and second fastener operable to securely fasten the second end to the drain pipe.

14. The drain hose assembly of claim 13, wherein the first and second fasteners are slip nut fasteners.

15. The drain hose assembly of claim 13, further comprising a U-bend pipe integrally coupled to the flexible hose and having a second end having a tailpiece configured to couple to a male pipe thread adapter coupled to a drain pipe.

16. The drain hose assembly of claim 14, further comprising a slotted reducing insert adaptor having a generally tubular shape with a longitudinal slot formed in its circumference, the insert further comprising an annular rib operable to engage a corresponding nub on one of the first and second slip nut fasteners.

17. The drain hose assembly of claim 13, further comprising an angled tailpiece configured for coupling the articulated extendable flexible hose to the sink drain.

18. The drain hose assembly of claim 13, further comprising an up to 90 degree tailpiece configured for coupling the articulated extendable flexible hose to the sink drain.

19. The drain hose assembly of claim 13, further comprising an extender pipe configured to couple the U-bend pipe to a drain pipe.

20. The drain hose assembly of claim 13, wherein the first end of the flexible hose further comprises a male pipe thread, and the second end of the flexible hose further comprises a tailpiece.
